(19) United States
(12) Patent Application Publication
(10) Pub. No.: US 2004/0073380 A1
(43) Pub. Date: Apr. 15, 2004

(54) Structural targets in hepatittis c virus ires element

(76) Inventor: Joseph D. Puglisi, Stanford, CA (US)

Correspondence Address: BOZICEVIC, FIELD & FRANCIS LLP, 200 MIDDLEFIELD RD, SUITE 200, MENLO PARK, CA, 94025, US

(21) Appl. No.: 10/332,626

(22) PCT Filed: Jul. 10, 2001
(86) PCT No.: PCT/US01/21871

(51) Int. Cl. G06F 19/00

(52) U.S. Cl. 702/25

(57) ABSTRACT

Molecular structures, computer representations thereof, and methods of analysis are provided for the hepatitis C virus internal ribosome entry site (HCV IRS). Novel features of the structure include the tetaloop fold in domain IIIe, including the array of three major groove exposed Watson-Crick faces (G295, A296, and U297), which loop has been found to be a point of direct contact with the 40S subunit; and the structure comprising the domain IIId loop E and hairpin loop backdone reversion, which places two S turns on the same side of hairpin loop structure.

Hepatitis C virus (HCV) is spread primarily through contact with infected blood and can cause cirrhosis, irreversible and potentially fatal liver scarring, liver cancer, or liver failure. It can lie dormant for 10 years or more before symptoms appear. Some patients will have no symptoms of liver damage, and their liver enzymes will stay at normal levels. Other patients have severe hepatitis C, with detectable HCV in their blood, liver enzymes elevated as much as 20 times more than normal, and a prognosis of ultimately developing cirrhosis and end-stage liver disease. The disease is responsible for between 8,000 and 10,000 deaths yearly, and is the major reason for liver transplants in the United States, accounting for 1,000 of the procedures annually. Chronic hepatitis C varies widely in its severity and outcome.

Presently, there is no vaccine or other means of preventing hepatitis C infection. HCV exists in many genotypes, making it difficult for researchers in their quest to develop a vaccine effective for all variations. Also, HCV mutates frequently within infected patients, so even if an effective vaccine is developed, it could be rendered useless by a new strain of mutant virus.

Currently, chronic hepatitis C patients who do not respond to therapy have few options. The only approved treatment for infection is interferon, which may be combined with other active agents.

The hepatitis C genome has an interesting feature, in that it possesses an internal ribosome entry site. Normal translation initiation in eukaryotes occurs by recognition of the 5′ cap structure of the mRNA by elF4E followed by assembly of other initiation factors and the 40S ribosomal subunit, and subsequent scanning of the 5′ UTR to the first AUG initiation codon. However, certain viral and other RNAs have been found to initiate translation in the absence of the 5′ cap, through an internal ribosome entry site (IRES). These regions of RNA have extensive secondary structure, allowing ribosome binding, although in most cases, the set of canonical factors that are important in cap-stimulated translation initiation have also been found to be important in IRES-mediated internal initiation, perhaps mediated by the direct binding of elF4F to the IRES element. The hepatitis C virus genome is included in this group (see Tsukiyama-Kohara et al. (1992) J. Virol. 66:147683; and Wang et al., (1993) J. Virol. 67:333844).

In HCV, IRES-mediated initiation eliminates the requirement for the 5′ cap structure and scanning. The 40S subunit is recruited directly to the vicinity of the start codon by interaction with the IRES element; and only a subset of the total translation initiation factors is required for this process. As such, IRES-mediated initiation in HCV and related pestiviruses is reminiscent of prokaryotic translational initiation, in which the Shine-Dalgarno interaction recruits 30S subunits directly to the start codon, and only 3 initiation factors are required.

The IRES structure is unique to the virus, and so-IRES-mediated translation is a potential drug target that can be exploited for inhibition of virus growth and replication. This invention describes the identification and three-dimensional structures of RNA domains that are required for IRES activity. The structures can be used for rational design of ligands to target IRES activity.

Relevant Literature

The HCV IRES element is a complex RNA secondary structure consisting of nucleotides 44 to 354 in the 5′UTR (Honda et al. (1996) Virology 222, 31-42). Biochemical experiments have demonstrated the roles of particular subdomains in IRES function. In particular, mutagenesis and functional data support a pseudoknot structure near the AUG start codon (Wang et al., (1995) RNA 1, 526-37). The sites of interaction with the 40S subunit have been mapped by toe-printing the subdomains including and adjacent to the pseudoknot structure (Pestova et al. (1998) Genes Dev. 12, 6783). Mutations within two hairpin loops, domain IIId and IIIe, disrupt IRES-mediated initiation (Psaridi et al. (1999) FEBS Left. 453, 49-53). Biochemical and small-angle x-ray scattering experiments suggested that the IRES has a metal-dependent tertiary structure, which may be required for interaction with 40S subunits (Kieft et al. (1999) J. Mol. Biol. 292, 513-29).

Rijnbrand et al. (2000) J Virol 2000 January; 74(2): 773-83 investigate the secondary structure of GB virus B (GBV-B), a hepatotropic flavivirus that is distantly related to hepatitis C virus (HCV). An internal ribosome entry site (IRES) bounded at its 5′ end by structural domain 11, a location analogous to the 5′ limit of the IRES in both the HCV and pestivirus 5′NTRs was found. IRES activity was absolutely dependent on (i) phylogenetically conserved, adenosine-containing bulge loops in domain III and (ii) the primary nucleotide sequence of stem-loop IIIe.

Odreman-Macchioli et al., (2000) Nucleic Acids Res 28(4): 875-85 focus on the major stem-loop region (domain III) and the binding of several cellular factors: two subunits of eukaryotic initiation factor elF3 and ribosomal protein S9. Binding of elF3 p170 and p116/p110 subunits was found to be dependent on the ability of the domain III apical stem-loop region to fold in the correct secondary structure whilst secondary structure of hairpin IIId is important for the binding of S9 ribosomal protein. Binding of S9 ribosomal protein also depends on the disposition of domain III on the HCV 5′ UTR, indicating the presence of necessary inter-domain interactions required for the binding of this protein. Klinck et al., (1998) Biochem Biophys Res Commun 247(3): 876-81 compare the internal ribosome entry sites (IRES) of members of the Enteroviridae-Rhinoviridae (E/R) family.

### SUMMARY OF THE INVENTION

Methods are provided for modeling the structure of the hepatitis C virus IRES (HCV IRES) element, and for identifying molecules that will bind to the HCV IRES, thereby blocking translation of the mRNA. Two RNA stem loops, domains IIId and IIIe, are involved in IRES-40S subunit interaction, and are targets for blocking agents. Preferred IRES blocking agents identified using the method of the invention act as viral growth inhibitors.

The methods of the invention entail structural modeling, and the identification and design of molecules having a particular structure. The methods rely on the use of precise structural information derived from NMR studies of the HCV IRES. This structural data permits the identification of atoms that are important for 40S ribosomal subunit binding. Other molecules that include atoms having a similar three dimensional arrangement similar to the interaction surface between the 40S subunit and the IRES are likely to be capable of blocking this interaction.

### BRIEF DESCRIPTION OF THE DRAWINGS

FIG. 1A shows the sequence and secondary structure of HCV IRES RNA (nucleotides 1-383 of HCV genotype 1b; SEQ ID NO:1). Domains are numbered according to Brown et al. (1992) N.A.R. 20:5041-5045. Nucleotides protected from kethoxal modification upon 40S subunit binding are indicated. Nucleotides that show increases in DMS modification upon 40S subunit binding (0) are indicated. FIG. 1(b) is an autoradiograph of kethoxal and DMS probing of HCV IRES RNA domains IIId and IIIe in the absence (−), or presence (⁺) of 40S subunits. The K lane is a primer extension reaction using the unmodified HCV IRES RNA. The kethoxal (ket) and DMS probing and primer extension reactions are performed as described under methods. The lanes marked U, G. C, and A are dideoxy sequencing reactions. FIG. 1(c) Sequence and secondary structure of the HCV IRES domain IIIe (SEQ ID NO:2) and IIId (SEQ ID NO:3) RNA oligonucleotides used for the NMR structural studies. Numbering according to FIG. 1a. Nucleotides, that were changed to improve transcription efficiency, are outlined.

FIG. 2(a) shows a stereo view from the major groove of the heavy-atom superposition of final 20 structures of HCV IRES domain IIIe. Bases are colored in blue and ribose-phosphate backbone in gray. FIG. 2(b) shows a single representative structures of the GNRA (SEQ ID NO:3) (Heus and Pardi (1991) Science 253-191-194)-and the GAUA (SEQ ID NO:4) tetraloop-of HCV IRES domain IIIe. Base nitrogens are in blue and base oxygens in red. Phosphorus atoms and phosphate oxygens are shown explicitly in yellow and red, respectively.

FIG. 3(a) is a stereo view of the heavy-atom superposition of final 25 structures of HCV IRES domain IIId. The color scheme is the same as in FIG. 2a. FIG. 3(b) is a single representative structure of the HCV IRES domain IIId, with both S turns highlighted. Ribose O4′ atoms are shown in red, the inverted riboses in blue and the phosphate backbone in yellow. FIG. 3(c) is a major groove view of the heavy-atom superposition of hairpin loop nucleotides G263-C270 of the final 25 structures of the HCV IRES domain IIId and a single representative structure. The color scheme is the same as in FIGS. 2a and 2b. Phosphorus atoms are shown in yellow. FIG. 3(d) is a minor groove view of the heavy-atom superposition of loop E nucleotides C272-G277 of the final 25 structures of the HCV IRES domain IIId and a single representative structure omitting the flanking G-C base pairs. The color scheme is the same as in FIG. 3c. FIG. 3(e) depicts the base pairing schemes found within the loop E motif of HCV IRES domain IIId. The color scheme is the same as in FIG. 2a. Hydrogen bonds shown by dashed lines are observed in all 25 final NMR structures.

Tables 4a, b and c contain the proton and 15N chemical shifts for HCV IRES domains.

### DETAILED DESCRIPTION OF THE EMBODIMENTS

Physical structures of the HCV IRES are provided. The structure information may be provided in a computer readable form, e.g. as a database of atomic coordinates, or as a three-dimensional model. The structures are useful, for example, in modeling interactions of the IRES with its binding partner, the 40S ribosome subunit. The structures are also used to identify non-ribosomal molecules that bind to the IRES element, and block the interaction with the 40S subunit.

### HCV IRES Structure

The coordinates for the HCV IRES domains are can be obtained from Lukavsky et al. (2000) Nat Struct Biol 7(12): 1105-10. These coordinates can be used in the design of structural models and screening methods according to the methods of the invention.

Two RNA stem loops, domains IIId and IIIe, are involved in IRES-40S subunit interaction, and are targets for blocking agents. The domain IIIe hairpin loop adopts a novel tetraloop fold. The hairpin is closed by a U294-G299 wobble pair, followed by a sheared G295-A298 base pair. The loop sequence (-GAUA-) does not conform to the standard GNRA motif, and adopts a different structure, wherein the bases of A296 and U297 point towards the major groove, and are not involved in RNA backbone contacts that would stabilize the loop fold; the two central nucleotides of the tetraloop stack on the 5′guanosine of the sheared G-A pair. This fold creates an array of three major groove exposed Watson-Crick faces (G295, A296, and U297). This loop was found to be a point of direct contact with the 40S subunit.

The domain IIId RNA forms a helical stem with non-canonical pairings, followed by a hexanucleotide loop region. The -UUGGGU- hairpin loop is more disordered than the other regions of the RNA. The central internal loop, which is highly conserved among HCV isolates, adopts the well-characterized loop E fold. Four consecutive nonanonical base pairs are formed—a sheared G256-A276 pair, a parallel A257-A275 pair, a reverse Hoogsteen U259-A274 pair and another sheared A260-G273 base pair. The arrangement of the base pairs within the loop E motif creates a continuous stack of four adenines (A260 and A274 to A276) with their Watson-Crick faces exposed to the minor groove. The internal loop is asymmetric, with the bulged G258 positioned in the major groove, where it forms a base triple with the U259-A274 reverse Hoogsteen pair. The phosphodiester backbone undergoes a local reversion of direction at A257 and G258, such that a parallel hydrogen bonding arrangement between A257 and A275 can form. The inversion in backbone direction leads to a characteristic S turn in the backbone between G256 to A259. The unusual backbone geometry within the loop E motif results from non A-form values for torsion angles β for G258 and A274 (gauche⁺), Y for A274 (trans), and e for A257 (gauche⁺) to allow for the triple formation and backbone inversion.

The sequence of the -UUGGGU-hairpin loop of domain IIId is absolutely conserved among all HCV isolates. The hairpin loop is separated from the loop E motif by a short helical stem consisting of a G-U wobble pair flanked by two G-C Watson-Crick base pairs, of which one closes the hairpin n the loop, U264 stacks on top of the loop closing G-C base pair, whereas U269 on the 3′ side is bulged into solution and disordered in the ensemble of NMR structures. This positions the ribose of G268 above the ribose of C270 of the loop-closing G-C base pair, which exposes the base of G268 to the major groove and introduces an inversion in backbone direction similar to the loop E motif with an S turn between G267 to C270. G267 stacks below G266 in the minor groove of the loop and U265 is located in the major groove, where it loosely stacks on the 5′-side residues and is more disordered compared to the three guanosine residues. The six base pair spacing between the loop E and the hairpin loop backbone reversion places both S turns on the same side of the hairpin loop structure. This creates a unique backbone feature for the domain IIId motif.

Those of skill in the art understand that a set of structure coordinates for a structure is a relative set of points that define a shape in three dimensions. In the present invention, a set of structures was generated that are consistent with the NMR spectral analyses. This range of structures (or ensemble) provided herein represents the error in measurement, and the real disorder in the actual structure due to the dynamic nature of the molecules.

It is possible that an entirely different set of coordinates could define a similar or identical shape. Moreover, slight variations caused by acceptable errors in the individual coordinates will have little, if any effect on overall shape. In terms of binding grooves, these acceptable variations would not be expected to alter the nature of ligands that could associate with those structures. The variations may be generated because of mathematical manipulations of the structure coordinates.

Alternatively, modifications in the NMR structure due to mutations, additions and deletions of nucleotides in the HCV RNA could also account for variations in structure coordinates. As discussed above, the ensemble of structures represents an acceptable standard of error for the coordinates. If variations in a related structure are within an acceptable standard error as compared to the original coordinates, the resulting three-dimensional shape is considered to be the same. Thus, for example, a ligand that bound to the HCV IRES may also be expected to bind to another IRES element whose structure coordinates defined a shape that falls within the acceptable error.

### Structural Models and Databases

HCV IRES structure models and databases of structure information are provided. The structure model may be implemented in hardware or software, or a combination of both. For most purposes, in order to use the structure coordinates generated for the IRES structure, it is necessary to convert them into a three-dimensional shape. This is achieved through the use of commercially available software that is capable of generating three-dimensional graphical representations of molecules or portions thereof from a set of structure coordinates.

In one embodiment of the invention, a machine-readable storage medium is provided, the medium comprising a data storage material encoded with machine readable data which, when using a machine programmed with instructions for using said data, is capable of displaying a graphical three-dimensional representation of any of the structures of this invention that have been described above. Specifically, the computer-readable storage medium is capable of displaying a graphical three-dimensional representation of the HCV IRES stem loops in one or both of domains IIId and IIIe.

Thus, in accordance with the present invention, data providing structural coordinates, alone or in combination with software capable of displaying the resulting three dimensional structure of the HCV IRES subdomains described above, portions thereof, and their structurally similar homologues, is stored in a machine-readable storage medium. Such data may be used for a variety of purposes, such as drug discovery, analysis of interactions between cellular components during translation, modeling of vaccines, and the like.

Preferably, the invention is implemented in computer programs executing on programmable computers, comprising a processor, a data storage system (including volatile and non-volatile memory and/or storage elements), at least one input device, and at least one output device. Program code is applied to input data to perform the functions described above and generate output information. The output information is applied to one or more output devices, in known fashion. The computer may be, for example, a personal computer, microcomputer, or workstation of conventional design.

Each programs preferably implemented in a high level procedural or object oriented programming language to communicate with a computer system. However, the programs can be implemented in assembly or machine language, if desired. In any case, the language may be a compiled or interpreted language.

Each such computer program is preferably stored on a storage media or device (e.g., ROM or magnetic diskette) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

### Design of HCV Binding Partners and Mimetics

The structure of the two HCV IRES stem loops, domains IIId and IIIe, are useful in the design of agents that block the interaction between the viral mRNA and 40S ribosome subunit, which agents may then inhibit translation of the viral mRNA. Agents of interest may comprise mimetics of the HCV IRES structure, which then compete for binding of the 40S subunit. Alternatively, the agents of interest may be an HCV binding agent, for example a structure that directly binds to the HCV IRES by having a physical shape that provides the appropriate contacts and space filling in the grooves of one or both of the domains.

For example, the structure encoded by the data may be computationally evaluated for its ability to associate with chemical entities. This provides insight into IRES element's ability to associate with chemical entities. Chemical entities that are capable of associating with these domains may inhibit translation from HCV mRNA. Such chemical entities are potential drug candidates. Alternatively, the structure encoded by the data may be displayed in a graphical format. This allows visual inspection of the structure, as well as visual inspection of the structure's association with chemical entities.

In one embodiment of the invention, a invention is provided for evaluating the ability of a chemical entity to associate with any of the molecules or molecular complexes set forth above. This method comprises the steps of employing computational means to perform a fitting operation between the chemical entity and the interacting surface of the RNA surface; and analyzing the results of the fitting operation to quantify the association. The term “chemical entity”, as used herein, refers to chemical compounds, complexes of at least two chemical compounds, and fragments of such compounds or complexes.

Molecular design techniques are used to design and select chemical entities, including inhibitory compounds, capable of binding to HCV IRES, particularly domain IIId and/or IIIe. Such chemical entities may interact directly with certain key features of the HCV IRES structure, including, without limitation, the novel tetraloop fold in domain IIIe, including the array of three major groove exposed Watson-Crick faces (G295, A296, and U297), which loop has been found to be a point of direct contact with the 40S subunit. Alternatively, inhibitory compounds may interact with the S turn in the backbone between G256 to A259, and particularly in the structure comprising the loop E and hairpin loop backbone reversion, which places both S turns on the same side of the hairpin loop structure. Such chemical entities and compounds may interact with either or both structures, in whole or in part.

It will be understood by those skilled in the art that not all of the atoms present in a significant contact residue need be present in a binding agent. In fact, it is only those few atoms which shape the loops and actually form important contacts with the 40S subunit that are likely to be important for activity. Those skilled in the art will be able to identify these important atoms based on the structure model of the invention, which can be constructed using the structural data herein.

The design of compounds that bind to or inhibit HCV IRES elements according to this invention generally involves consideration of two factors. First, the compound must be capable of either competing for bind with; or physically and structurally associating with the domains described above. Non-covalent molecular interactions important in this association include hydrogen bonding, van der Waals interactions, hydrophobic interactions and electrostatic interactions.

The compound must be able to assume a conformation that allows it to associate or compete with the IRES element. Although certain portions of the compound will not directly participate in these associations, those portions of the may still influence the overall conformation of the molecule. This, in turn, may have a significant impact on potency. Such conformational requirements include the overall three-dimensional structure and orientation of the chemical entity in relation to all or a portion of the binding pocket, or the spacing between functional groups of an entity comprising several interacting chemical moieties.

Computer-based methods of analysis fall into two broad classes: database methods and de novo design methods. In database methods the compound of interest is compared to all compounds present in a database of chemical structures and compounds whose structure is in some way similar to the compound of interest are identified. The structures in the database are based on either experimental data, generated by NMR or x-ray crystallography, or modeled three-dimensional structures based on two-dimensional data. In de novo design methods, models of compounds whose structure is in some way similar to the compound of interest are generated by a computer program using information derived from known structures, e.g. data generated by x-ray crystallography and/or theoretical rules. Such design methods can build a compound having a desired structure in either an atom-by-atom manner or by assembling stored small molecular fragments. Selected fragments or chemical entities may then be positioned in a variety of orientations, or docked, within the interacting surface of the RNA. Docking may be accomplished using software such as Quanta (Molecular Simulations, San Diego, Calif.) and Sybyl, followed by energy minimization and molecular dynamics with standard molecular mechanics force fields, such as CHARMM and AMBER.

Specialized computer programs may also assist in the process of selecting fragments or chemical entities. These include: GRID (Goodford (1985) J. Med. Chem., 28, pp. 849857; Oxford University, Oxford, UK; MCSS (Miranker et al. (1991) Proteins: Structure, Function and Genetics, 11, pp. 29-34; Molecular Simulations, San Diego, Calif.); AUTODOCK (Goodsell et al., (1990) Proteins: Structure, Function, and Genetics, 8, pp. 195-202; Scripps Research Institute, La Jolla, Calif.); and DOCK (Kuntz et al. (1982) J. Mol. Biol., 161:269-288; University of California, San Francisco, Calif.)

Once suitable chemical entities or fragments have been selected, they can be assembled into a single compound or complex. Assembly may be preceded by visual inspection of the relationship of the fragments to each other on the three-dimensional image displayed on a computer screen in relation to the structure coordinates. Useful programs to aid one of skill in the art in connecting the individual chemical entities or fragments include: CAVEAT (Bartlett et al., (1989) In Molecular Recognition in Chemical and Biological Problems”, Special Pub., Royal Chem. Soc., 78, pp. 182-196; University of California, Berkeley, Calif.); 3D Database systems such as MACCS-3D (MDL Information Systems, San Leandro, Calif); and HOOK (available from Molecular Simulations, San Diego, Calif.).

Other molecular modelling techniques may also be employed in accordance with this invention. See, e.g., N. C. Cohen et al., “Molecular Modeling Software and Methods for Medicinal Chemistry, J. Med. Chem., 33, pp. 883-894 (1990). See also, M. A. Navia et al., “The Use of Structural Information in Drug Design”, Current Opinions in Structural Biology, 2, pp. 202-210 (1992).

Once the binding entity has been optimally selected or designed, as described above, substitutions may then be made in some of its atoms or side groups in order to improve or modify its binding properties. Generally, initial substitutions are conservative, i.e., the replacement group will have approximately the same size, shape, hydrophobicity and charge as the original group. It should, of course, be understood that components known in the art to alter conformation should be avoided. Such substituted chemical compounds may then be analyzed for efficiency of fit by the same computer methods described above.

Another approach made possible and enabled by this invention, is the computational screening of small molecule databases for chemical entities or compounds that can bind in whole, or in part, to the IRES element. In this screening, the quality of fit of such entities to the binding site may be judged either by shape complementarity or by estimated interaction energy.

### Biological Screening

The success of both database and de novo methods in identifying compounds with activities similar to the compound of interest depends on the identification of the functionally relevant portion of the compound of interest. For drugs, the functionally relevant portion may be referred to as a pharmacophore, i.e. an arrangement of structural features and functional groups important for biological activity. Not all identified compounds having the desired pharmacophore will act as an inhibitor of HCV translation. The actual activity can be finally determined only by measuring the activity of the compound in relevant biological assays. However, the methods of the invention are extremely valuable because they can be used to greatly reduce the number of compounds which must be tested to identify an actual inhibitor.

In order to determine the biological activity of a candidate pharmacophore it is preferable to measure biological activity at several concentrations of candidate compound. The activity at a given concentration of candidate compound can be tested in a number of ways. The physical interactions are tested by combining the HCV genome or fragment thereof with the candidate compound. Preferred genomic fragments include the region of the HCV IRES, as described in the examples, or oligonucleotide fragments derived therefrom. Optionally, the binding assay will further comprise a 40 S ribosome subunit or fragment derived therefrom, where binding of the ribosome subunit to the HCV IRES is quantitated.

In addition to the binding assays, biological assays may be performed. For example, one may test the effect of a candidate compound on protein translation, by monitoring the synthesis of HCV proteins in the presence or absence of the candidate agent. Agents may also be tested in a cellular setting, for example to monitor the production of viral particles in the absence or presence of the candidate agent.

### Experimental

The following examples are put forth so as to provide those of ordinary skill in the art with a complete disclosure and description of how to make and use the subject invention, and are not intended to limit the scope of what is regarded as the invention. Efforts have been made to ensure accuracy with respect to the numbers used (e.g. amounts, temperature, concentrations, etc.) but some experimental errors and deviations should be allowed for. Unless otherwise indicated, parts are parts by weight, molecular weight is average molecular weight, temperature is in degrees centigrade; and pressure is at or near atmospheric.

Biochemical and functional data are presented that support the direct role of domain IIId and IIIe hairpins in IRES interaction with the 40S subunit. The structures of these two RNA domains were determined by NMR spectroscopy. These results further support the role of IRES RNA structure in recognition of the 40S ribosomal subunit.

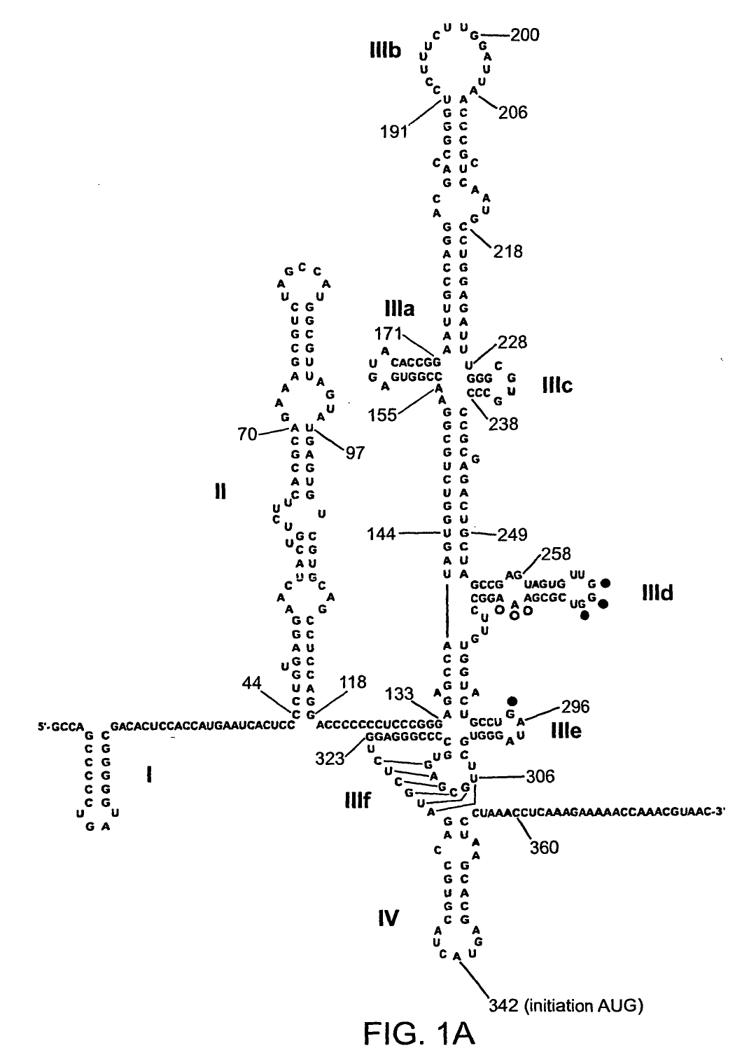

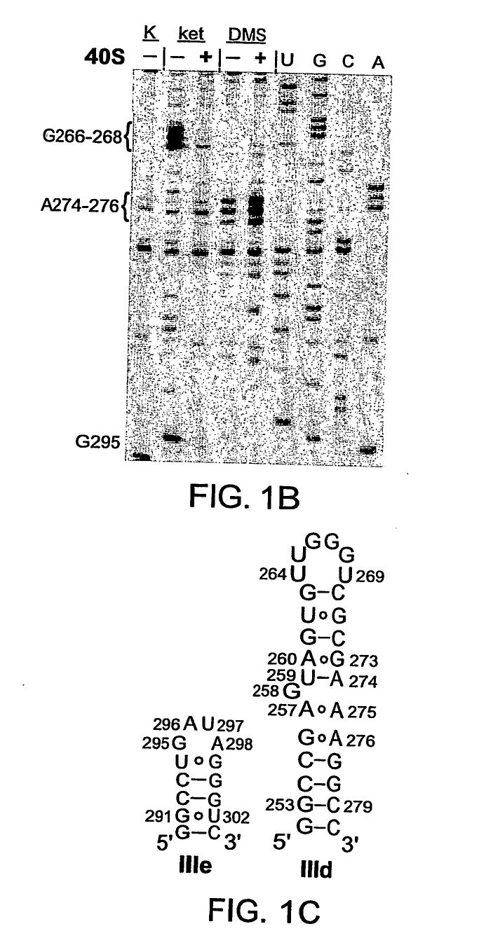

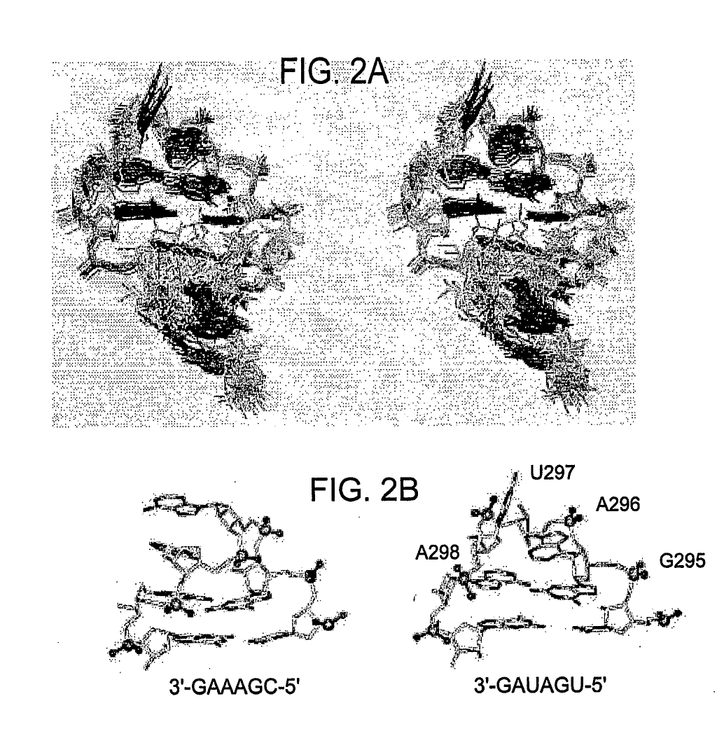

The HCV IRES binds directly to the 40S ribosomal subunit in the absence of external factors. To map the regions of the IRES that may interact with 40S subunits, chemical probing was performed on the IRES RNA (domain IV and the 3′ half of domain III) in the absence or presence of ribosomal subunits. The chemical reactivity of the unbound IRES is consistent with the well-characterized secondary structure of the IRES (shown in FIG. 1a). Base reactivities are dependent upon the Mg²⁺ concentration, consistent with the previously defined Mg²⁺-dependent formation of tertiary structure for the IRES (Kieft et al., supra.)

Upon binding of the folded IRES to 40S subunits, two regions of the IRES show strong changes in reactivity (FIG. 1b). Guanosines in the hairpin loops of domains IIId and IIIe are strongly reactive to kethoxal in the unbound IRES, and are almost completely protected upon 40S binding. In contrast, three adenosines in the stem of domain IIId show increases in reactivity upon 40S subunit binding. These loops are required for IRES function in vivo and in vitro.

To understand further the role of domains IIId and IIIe in IRES function, we determined both structures using NMR spectroscopy (FIG. 1c). For domain IIIe, a 14 residue RNA oligonucleotide, corresponding to nucleotides 291 to 302 was studied using homonuclear NMR methods. The spectra were readily assigned without isotopic labeling, and a total of 271 NOE and 88 dihedral torsion angle restraints were obtained. For domain IIId, a 29 residue RNA oligonucleotide, corresponding to nucleotides 253 to 279, was studied by NMR spectroscopy. A combination of homonuclear and heteronuclear 2D and 3D NMR methods yielded a total number of 705 NOE and 200 dihedral torsion angle restraints. Measurement of intra base pair ²J_{NN} couplings across hydrogen bonds was employed to establish base pairing schemes. For both hairpin loops, solely NMR-derived restraints were used for structure calculations.

The domain IIIe hairpin loop adopts a novel tetraloop fold and is well defined by the NMR data (heavy atom r.m.s.d.=0.89 Å, FIG. 2a). The hairpin is closed by a U294-G299 wobble pair, followed by a sheared G295-A298 base pair (FIG. 2b). Similar pairing interactions are observed in the GNRA tetraloops and in purine-rich hexaloops. The loop sequence (-GAUA-), however, does not conform to the standard GNRA motif, and adopts a different structure. The bases of A296 and U297 point towards the major groove, and are not involved in RNA backbone contacts that would stabilize the loop fold; the two central nucleotides of the tetraloop stack on the 5′guanosine of theLsheared G-A pair. This fold creates an array of three major groove exposed Watson-Crick faces (G295, A296, and U297). In contrast, the central purine and adenosine in a GNRA tetraloop point towards the minor groove, and are stacked on the 3′adenosine of the sheared G-A pair (FIG. 2b).

The sequence of the GAUA tetraloop is conserved among all HCV isolates, and among related pestiviridae IRES. Our biochemical studies suggest that this loop is a point of direct contact with the 40S subunit. G295, which is exposed to the major groove, is strongly reactive to kethoxal in the free IRES and is protected from chemical modification upon 40S binding (FIG. 1b). The importance of the IIIe tetraloop for IRES function was also supported by translation in cultured cells of wild-type HCV IRES and mutants of the GAUA tetraloop motif. Mutation of the major groove exposed base U297 to a cytosine residue causes a more than 50% decrease in IRES mediated translation compared to wild type (Table 3). Converting the GAUA tetraloop into the GNRA tetraloop sequence by mutating U297 to an adenine residue, causes the same decrease in IRES activity. These data are consistent with a previous mutational study of domain IIIe, which showed that virtually any alteration of the loop sequence caused a significant decrease in IRES activity. The presentation of bases by the domain IIIe tetraloop may be required for the IRES-40S subunit interaction.

TABLE 3
Translational efficiencies of HCV IRES elements.

| Genotype^{a} | Activity (%) |
|---|---|
| Wild-type | 100 |
| U297C | 45 |
| U297A | 45 |
| G266-268A | 50 |

^{a}All dicistronic vectors contain an additional mutation of the HCV AUG start codon to CUG, which did not affect translational activity. All mRNAs displayed similar intracellular stabilities, as determined by Northern analysis.

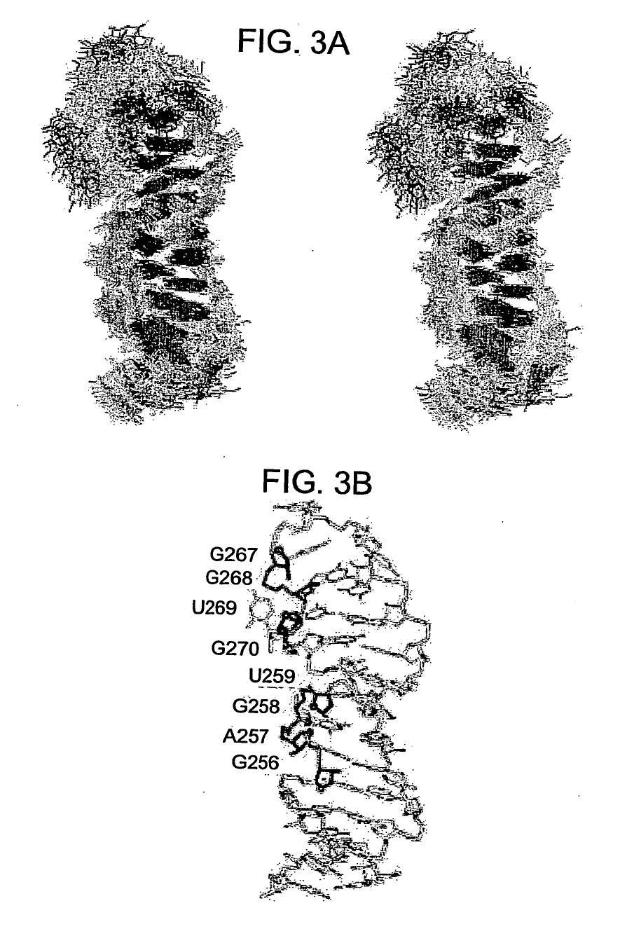

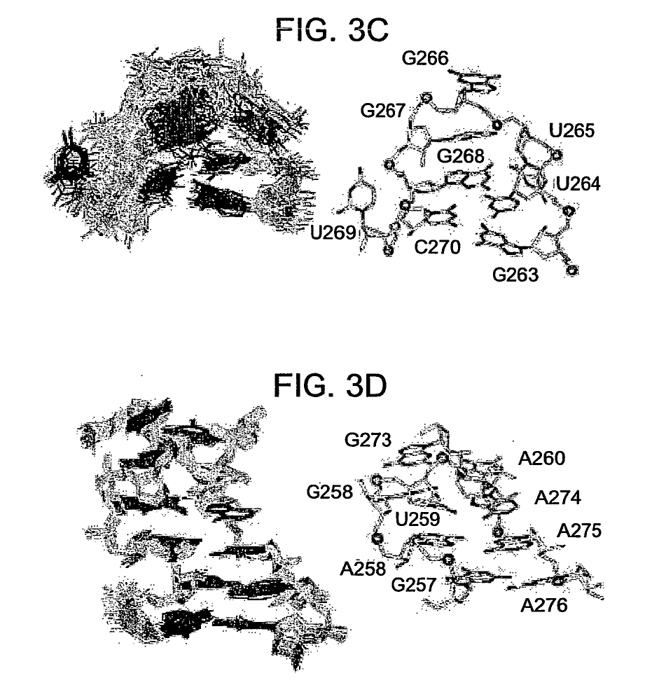

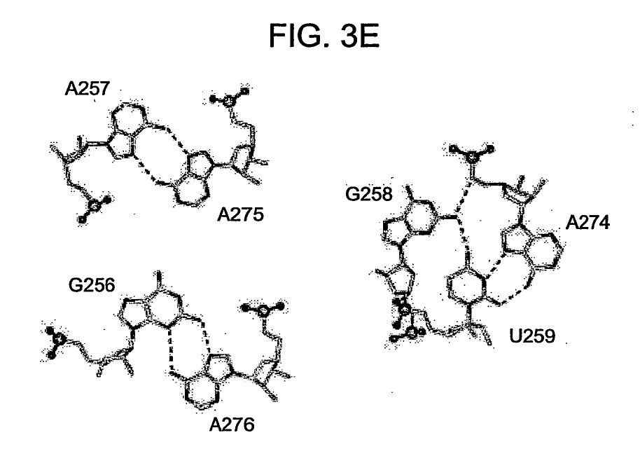

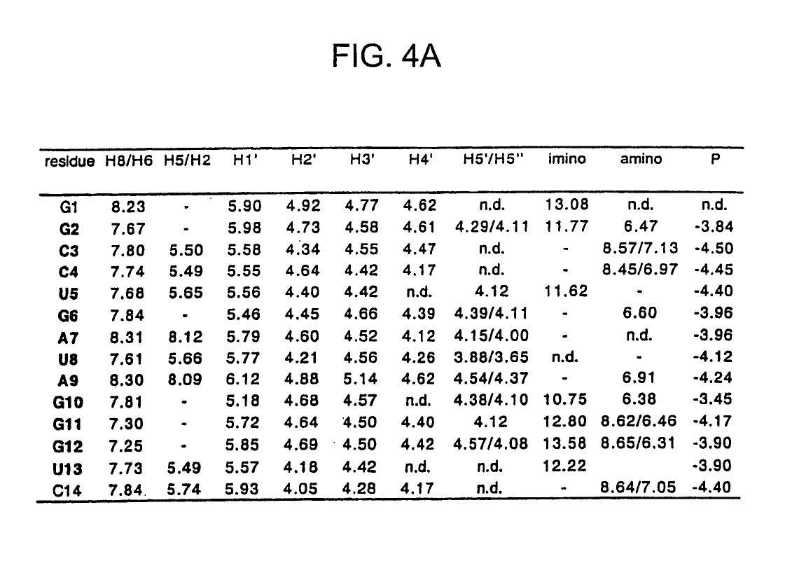

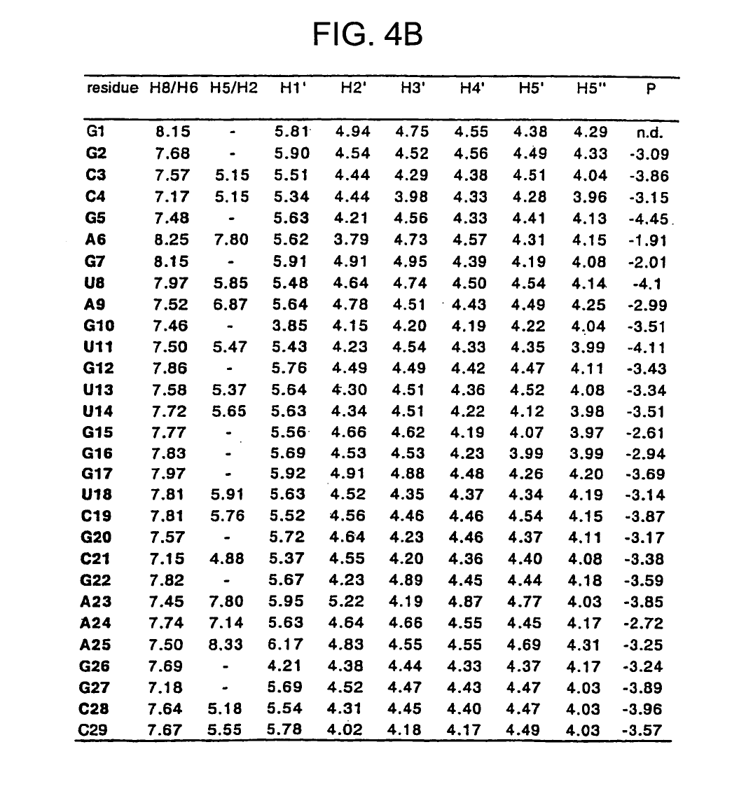

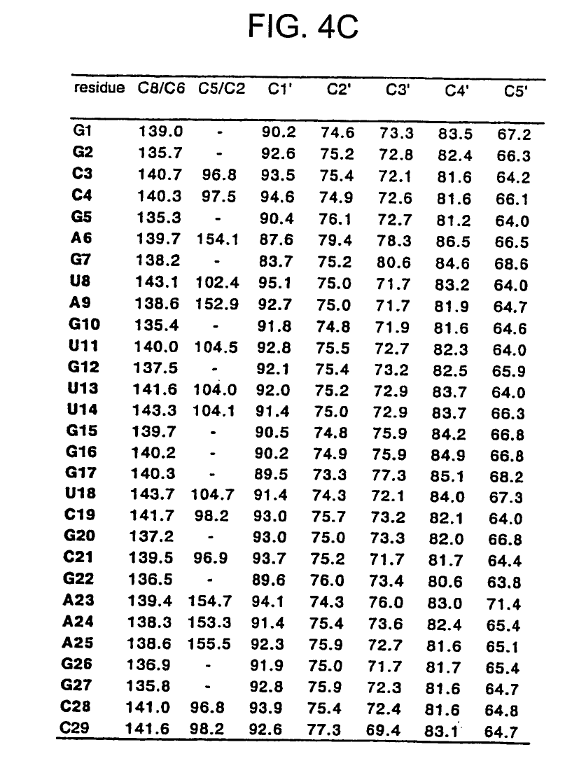

The domain IIId RNA forms a helical stem with non-canonical pairings, followed by a hexanucleotide loop region. The overall structure is well defined by the NMR data (heavy atom r.m.s.d.=1.61 Å, FIG. 3a). The -UUGGGU- hairpin loop is more disordered than the other regions of the RNA; the heavy atom r.m.s.d; for U264 to U269 is 1.46 Å (FIG. 3&). The central internal loop, which is highly conserved among HCV isolates, adopts the well-characterized loop E fold, and is very well defined by the NMR data (r.m.s.d. of 0.28 Å, FIG. 3d). Four consecutive non-canonical base pairs are formed—a sheared G256-A276 pair, a parallel A257-A275 pair, a reverse Hoogsteen U259-A274 pair and another sheared A260-G273 base pair (FIG. 3e). The reverse Hoogsteen hydrogen bonding scheme is supported by the observation of internucleotide ²J_{NN} scalar couplings. The arrangement of the base pairs within the loop E motif creates a continous stack of four adenines (A260 and A274 to A276) with their Watson-Crick faces exposed to the minor groove (FIG. 3d). The internal loop is asymmetric, with the bulged G258 positioned in the major groove, where it forms a base triple with the U259-A274 reverse Hoogsteen pair (FIG. 3e). The phosphodiester backbone undergoes a local reversion of direction at A257 and G258, such that a paralles hydrogen bonding arrangement between A257 and A275 can form. The inversion in backbone direction leads to a characteristic S turn in the backbone between G256 to A259 (FIG. 3b). The unusual backbone geometry within the loop E motif results from non A-form values for torsion angles β for G258 and A274 (gauche⁺), γ for A274 (trans), and c for A257 (gauche⁺) to allow for the triple formation and backbone inversion. The structure also explains unusual ¹H, ¹³C, and ³¹P chemical shifts observed for several loop E resonances.

The loop E motif is common in RNAs, with different sequence families. All loop E motifs contain a sheared G-A pair and the adjacent U-A pair. In prokaryotic 5S ribosomal RNA, a loop E motif is observed with a symmetric internal loop: a G-G pair and sheared G-A pair. In eukaryotic 28S ribosomal RNA, the sarcin-ricin loop (SRL) contains a loop E motif that contains the A-A pair, bulged G, U-A pair and G-A pair; the r.m.s.d. between the crystal structure of SRL and the HCV IRES domain IIId loop E motif is 1.15 Å. The SRL has a flexible region adjacent to the loop E motif, whereas in domain IIId the loop E is bordered by a sheared G-A pair and Watson-Crick base pairs. Loop E motifs present rich hydrogen bonding potential in both the minor and major groove for both RNA-RNA and RNA-protein interactions.

The sequence of the -UUGGGU-hairpin loop of domain IIId is absolutely conserved among all HCV isolates. The hairpin loop is separated from the loop E motif by a short helical stem consisting of a G-U wobble pair flanked by two G-C Watson-Crick base pairs, of which one closes the hairpin loop. On the side of the loop, U264 stacks on top of the loop closing G-C base pair, whereas U269 on the 3′ side is bulged into solution and disordered in the ensemble of NMR structures (FIG. 3c). This positions the ribose of G268 above the ribose of C270 of the loop-closing G-C base pair, which exposes the base of G268 to the major groove and introduces an inversion in backbone direction similar to the loop E motif with an S turn between G267 to C270 (FIG. 3b). G267 stacks below G266 in-the minor groove of the loop and U265 is located in the major groove, where it loosely stacks on the 5′-side residues and is more disordered compared to the three guanosine residues. The six base pair spacing between the loop E and the hairpin loop backbone reversion places both S turns on the same side of the hairpin loop structure. This creates a unique backbone feature for the domain IIId motif.

The domain IIId hairpin loop clearly plays an important role in IRES40S subunit interaction. In the chemical probing experiments discussed above, the Watson-Crick faces of G266, G267 and G268 were strongly protected from reaction with kethoxal in the IRES40S subunit complex (FIG. 1b). In addition, the N7 positions of G266 and G267 are protected from methylation by dimethyl sulfate in the IRES40S complex, whereas the N7 of G268, which is exposed on the major groove side of the IIId loop, is highly reactive in the complex. The three guanosines in the loop are required for full IRES activity in internal initiation. Mutation of the three loop guanosines to cytosines had been previously shown to be deleterious to IRES activity. Based on our structural data, we mutated all three guanosine residues (G266-G268) to adenines preserving purine residues in those positions in order to maintain the loop fold. Those mutations decreased IRES-mediated translation by 50% (Table 3).

What is the role of the loop E motif in domain IIId. The ability to form a loop E fold is conserved among HCV isolates. An observed change is G256-A276 to a U-C pair in HCV isolate HCV-2b, which would lead to the SRL loop E motif. Our preliminary data indicate that mutations that disrupt the loop E motif are deleterious to IRES function. The loop E motif, with its narrowed major groove, distorted phosphodiester backbone, and stretch of non-canonical pairings, may be involved in RNA tertiary interactions within the IRES, or intermolecular interactions with the 40S subunit; the interactions with the ribosome may be with protein or RNA components. The adenosine N1—positions of A274 to A276 in the minor groove of the loop E motif are highly accessible to modification by DMS in the IRES40S subunit complex (FIG. 1b). Therefore, protein-or RNA interactions with the loop E motif likely occur on the major groove side.

The results presented here demonstrate that two surface-accessible stem loops in the HCV IRES are involved in complex formation with 40S ribosomal subunits. The novel structures of both domain IIId and IIIe are suggestive of their involvement in IRES function, and suggest experiments for a molecular level understanding of HCV IRES function. The work presented here demonstrates the powerful ability of RNA NMR to provide local structural information to drive biochemical studies of a large RNA system.

Methods

Sample preparation. RNA oligonucleotides were prepared by transcription from DNA templates by phage T7 RNA polymerase and purified using polyacrylamide gel electrophoresis (Puglisi et al. (1995) Methods Enzymol. 261, 323-50). Unlabeled and ¹³C, ¹⁵N-labeled RNAs were prepared. Labeled nucleoside triphosphates were prepared in-house using published methods (Batey et al. (1992) Nucleic Acids Res. 20, 4515-23). RNAs were electroeluted from the gel and subsequently dialyzed against final buffer (10 mM Na phosphate, pH 6.4, 1 mM d₁₂-EDTA, 4% D₂O or 100% D₂O). NMR samples were prepared in a Shigemi NMR tube (sample volume 250 μL) at RNA concentrations of 1.0-2.5 mM.

NMR Spectral analyses. NMR data were acquired at either 15 or 25° C. on Varian Inova 500 MHz and 800 MHz NMR spectrometers equipped with triple resonance x,y,z-axis gradient probes. ¹H, ¹³C, ¹⁵N, and ³¹P assignments were obtained using standard homonuclear and heteronuclear methods optimized for RNA structure determination (RnaPack, Varian User Library). In short, constant time HSQC, 3D HCCH-TOCSY, 3D HCCH-COSY, and 2D HCCH-RELAY experiments were used to assign sugar spin systems, while through-backbone assignments were made with HCP and HP-COSY experiments (Marino et al. (1994) J. Am. Chem. Soc. 116, 6472-6473).

Base exchangeable protons were assigned by correlation to non-exchangeable base protons using heterdTOCSY methods. Intranucleotide H1′ to base proton correlations were obtained using a 2D MQ-HCN experiment (Marino et al. (1997) J. Am. Chem. Soc. 119, 7361-7366). NOE distance restraints from non-exchangeable protons were obtained from 2D-NOESY experiments (100% D₂O) with mixing times of 50, 150 and 250 ms. Exchangeable proton NOEs were determined using SS-NOESY (Smallcombe (1993) J. Am. Chem. Soc. 115, 4776-4785) or WATERGATE-NOESY experiments (4% D₂O) with mixing times of 50 and 150 ms. A 3D ¹³Cedited NOESY-HSQC experiment (4% D₂O) with a mixing time of 150 ms was used to confirm both non-exchangeable and exchangeable proton NOE assignments.

Base pairing schemes for IIId were established using the HNN-COSY experiment (Dingley & Grzesiek (1998) J. Am. Chem. Soc. 120, 8293-8297). NOEs from exchangeable protons were characterized as either strong,(0-3.5 Å), medium (0-4.5 Å) or weak (0-6 Å), while NOEs from non-exchangeable protons were characterized as either strong (0-3 Å), medium (0-4 Å), weak (0-5 Å) or very weak (0-6 Å). Dihedral torsion restraints were obtained from DQF-COSY, 3D HMQC-TOCSY, HP-COSY and HCP experiments, as described previously (Fourmy et al. (1998) J. Mol. Biol. 277, 33345).

Structure calculation. Structures were calculated using a simulated annealing protocol within the X-PLOR 3.1 package (Brünger, A. T. X-PLOR (Version 3.1) A System for X-ray Crystallography and NMR. Yale University Press, New Haven, Conn. (1993). The protocol for structural calculations included two stages; simulated annealing of starting structures with random angles and restrained molecular dynamics (rMD) refinement. A total of 699 NOE distance restraints, 6 NN hydrogen bond distance restraints and 200 dihedral restraints for IIId and 271 NOE distance restraints and 88 dihedral restraints for IIIe were used. The NOE distance force constants were set to 50 kcal mol⁻¹ Å⁻² and torsion angle force constants were varied from 5 to 50 kcal mol⁻¹ rad⁻² during calculations. No hydrogen bonding restraints other than experimentally measured ones were used in calculations.

A total of 100 starting structures were generated and subjected to a simulated annealing protocol. This consisted of 500 cycles of energy minimization, followed by rMD at 1000 K with low values for interatomic repulsion, and subsequent rMD with increasing values for interatomic repulsion while cooling to 300 K A final minimization step with 1000 cycles was performed, which included a Lennard-Jones potential and no electrostatic terms. The 100 structures were then subjected to a refinement procedure: 500 steps of restrained energy minimization; rMD at 1000 K while increasing the torsion angle force constant; rMD while cooling to 300 K and finally 1000 cycles of energy minimization, which included a Lennard-Jones potential, but no electrostatic terms. The final structures (25 IIId or 20 IIIe) were chosen, which had the lowest total and restraint violation energies, whereas non-converged structures were at least one standard deviation higher in total and restraint violation energy. Structures have been submitted to the Protein Data Bank.

Chemical Probing. 40S subunits were isolated from HeLa S3 cell pellets (National Cell Culture Center) by the puromycin method of Blobel and Sabatini (Blobel & Sabatini (1971) Proc. Natl. Acad. Sci. U.S. A. 68, 3904). HCV IRES RNA (nt 40-375) was generated by T7 RNA polymerase run-off transcription and purified by gel electrophoresis. Chemical modification with kethoxal and DMS was performed essentially as described in Moazed and Noller (1986) Cell 47, 985-94. Reactions were performed with an excess of 40S subunits in 125 mM KOAc, 10 mM MgCl₂, 30 mM HEPES-KOH (pH 7.0) and 0.5 mM Spermidine. Sodium borohydride reduction and aniline-induced strand scission of DMS modified IRES was also performed (Peattie (1979) Proc. Natl. Acad. Sci. U.S. A. 76, 17604). Primer extension, using a primer complementary to the HCV IRES ORF, was used to detect sites of RNA base modification (Stern et al. (1988) Methods Enzymol. 164, 481-9). Body labeled products were separated on an 8% 7M Urea, 1×TBE acrylamide gel and detected by autoradiography.

Construction of dual luciferase reporter constructs and translation assays. Wildtype (Tsukiyama-Kohara et al. (1992) J. Virol. 66, 1476-83) and mutated HCV IRES elements were subcloned into the intercistronic region of a dicistronic luciferase reporter construct, as described previously (Johannes et al. (1999) Proc. Natl. Acad. Sci. U.S. A 96, 13118-13123).

DNA plasmids were transfected into HeLa cells using the FuGENE 6 transfection reagent (Boehringer Mannheim). Transfected Cells were harvested 24 hours after transfection and luciferase activities were measured using the Dual Luciferase Reporter Assay System (Promega-Biotech).

Northern analysis. Total RNA was harvested from transfected HeLa cells 24 hours after transfection using the Trizol reagent (Gibco/BRL). Polyadenosine-containing (polyA⁺) RNA was isolated from the total RNA using the Oligotex mRNA Kit (Qiagen). Approximately 1 μg of polyA+ RNA was separated on a formaldehyde-containing gel and transferred to a nitrocellulose membrane. Radiolabled probe was generated from a PCR product corresponding to nucleotides 648-1280 of the firefly luciferase gene using the RadPrime Kit (Gibco/BRL) and hybridized to the membrane using Express-hyb solution (Clonetech).

TABLE 1
Structural statistics and atomic root-mean-square
(r.m.s.) deviations for domain IIIe RNA oligonucleotide.

| | | <SA> |
|---|---|---|
| | | versus |
| | <SA>* | SA |
| final forcing energies | 15.9 ± 0.8 | |
| distance and dihedral restraints (kcal · mol⁻¹) | | |
| r.m.s. deviation from experimental | 0.0316 ± 0.0009 | |
| distance restraints (Å)^{‡} | | |
| (271) | | |
| r.m.s. deviation from experimental | 0.9459 ± 0.0427 | |
| dihedral restraints (degrees) | | |
| (88) | | |
| Deviations from idealized geometry | | |
| Bonds (Å) | 0.0035 ± 0.0001 | |
| Angle (degrees) | 0.8416 ± 0.0108 | |
| Impropers (degrees) | 0.2218 ± 0.0135 | |
| Heavy-atoms r.m.s. deviation (Å) | | 0.89 |
| All RNA | | |
| Heavy-atoms r.m.s. deviation (Å) | | 0.19 |
| Loop (U294 to G299) | | |

*<SA> refers to the final 20 simulated annealing structures, SA to the average structure obtained by taking the average coordinates of the 20 simulated annealing structures best-fitted to one another.
^{‡}the 20 final structures did not contain distance violations of >0.25 Å or dihedral violations of >5°. Numbers in parentheses refer to number of restraints.

TABLE 2
Structural statistics and atomic root-mean-square (r.m.s.)
deviations for domain IIId RNA oligonucleotide.

| | | <SA> |
|---|---|---|
| | | versus |
| | <SA>* | SA |
| final forcing energies | 29.9 ± 0.7 | |
| distance and dihedral restraints (kcal · mol⁻¹) | | |
| r.m.s. deviation from experimental | 0.0261 ± 0.0006 | |
| distance restraints (Å)^{‡} | | |
| (705) | | |
| r.m.s. deviation from experimental | 0.9800 ± 0.0623 | |
| dihedral restraints (degrees) | | |
| (200) | | |
| Deviations from idealized geometry | | |
| Bonds (Å) | 0.0036 ± 0.0001 | |
| Angle (degrees) | 0.8572 ± 0.0049 | |
| Impropers (degrees) | 0.2491 ± 0.0101 | |
| Heavy-atoms r.m.s. deviation (Å) | | 1.61 |
| All RNA | | |
| Heavy-atoms r.rn.s. deviation (Å) | | |
| Loop E motif (G256-A260, G273-A276) | | 0.28 |
| Hairpin loop (U264-U269) | | 1.46 |

*<SA> refers to the final 25 simulated annealing structures, SA to the average structure obtained by taking the average coordinates of the 25 simulated annealing structures best-fitted to one another.
^{‡}the 25 final structures did not contain distance violations of >0.25 Å or dihedral violations of >5°. Numbers in parentheses refer to number of restraints.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A computer for producing a three-dimensional representation of a molecule wherein said molecule comprises a hepatitis virus C IRES element, wherein said computer comprises:
a machine-readable data storage medium comprising a data storage material encoded with machine-readable data, wherein said data comprises the three-dimensional coordinates of a subset of the atoms in nucleotides 1-383 of HCV genotype 1b;
a working memory for storing instructions for processing said machine-readable data;
a central-processing unit coupled to said working memory and to said machine-readable data storage medium for processing said machine readable data into said three-dimensional representation; and
a display coupled to said central-processing unit for displaying said three-dimensional representation.

2. The computer of claim 1, wherein said data comprises the three-dimensional coordinates of the IRES domain IIIe of HCV genotype lb.

3. The computer of claim 1, wherein said data comprises the three-dimensional coordinates of the IRES domain IIId of HCV genotype 1b.

4. A database comprising:
a machine-readable data storage medium comprising a data storage material encoded with machine-readable data, wherein said data comprises the three-dimensional coordinates of a subset of the atoms in nucleotides 1-383 of HCV genotype 1 b.

5. The database of claim 4, wherein said data comprises the three-dimensional coordinates of the IRES domain IIIe of HCV genotype 1b.

6. The database of claim 4, wherein said data comprises the three-dimensional coordinates of the IRES domain IIId of HCV genotype 1b.

7. A computer-assisted method for identifying potential inhibitors of hepatitis C virus translation, using a programmed computer comprising a processor, a data storage system, an input device, and an output device, comprising the steps of:
(a) inputting into the programmed computer through said input device data comprising the three-dimensional coordinates of a subset of the atoms in nucleotides 1-383 of HCV genotype 1b, thereby generating a criteria data set;
(b) comparing, using said processor, said criteria data set to a computer database of chemical structures stored in said computer data storage system;
(c) selecting from said database, using computer methods, chemical structures having a portion that is structurally similar to said criteria data set;
(d) outputting to said output device the selected chemical structures having a portion similar to said criteria data set.

8. The method of claim 7, wherein said data comprises the three-dimensional coordinates of the IRES domain IIIe of HCV genotype 1b.

9. The method of claim 7, wherein said data comprises the three-dimensional coordinates of the IRES domain IIId of HCV genotype 1b.

10. A compound having a chemical structure selected using the method of claim 7.


SEQUENCE LISTING (5 sequences)

SEQ ID NO: 1 - RNA, 384 nt, Hepatitis C virus
gccagcccccugaugggggcgacacuccaccaugaaucacuccccugugaggaacuacugucuucacgcagaaagcgucuagccauggcguuaguaugagugucgugcagccuccaggaccccccccucccgggagagccauaguggucugcggaaccggugaguacaccggaauugccaggacgaccggguccuuucuuggauaaacccgcucaaugccuggagauuugggcgugcccccgcaagacugcuagccgaguaguguugggucgcgaaaggccuugugguacugccugauagggugcuugcgagugccccgggaggucucguagaccgugcaucaugagcacgaauccuaaaccucaaagaaaaaccaaacguaac

SEQ ID NO: 2 - RNA, 14 nt, Hepatitis C virus
ggccugauaggguc

SEQ ID NO: 3 - RNA, 29 nt, Hepatitis C virus
ggccgaguaguguugggucgcgaaaggcc

SEQ ID NO: 4 - RNA, 6 nt, Hepatitis C virus
gaaagc

SEQ ID NO: 5 - RNA, 6 nt, Hepatitis C virus
gauagu